(19) United States
(12) Patent Application Publication
(10) Pub. No.: US 2004/0121299 A1
(43) Pub. Date: Jun. 24, 2004

(54) System and method for remote-access virtual-lab environment

(75) Inventors: Bruce A. Rougeau, Plano, TX (US); James T. Crawford, Allen, TX (US); Shelby Smith, Allen, TX (US)

Correspondence Address: DOCKET CLERK, DM/EDS, P.O. DRAWER 800889, DALLAS, TX, 75380, US

(73) Assignee: Electronic Data Systems Corporation, Plano, TX

(21) Appl. No.: 10/326,866

(22) Filed: Dec. 20, 2002

(51) Int. Cl. G09B 25/00; G09B 3/00

(52) U.S. Cl. 434/365

(57) ABSTRACT

A system, method, and computer program product for a remotely accessible, on-line virtual-system education lab. In this embodiment, students can connect with the lab server from any client system connected, directly or indirectly, with a common network, using a conventional web browser or other thin client. When the client connects, the server will create a virtual lab computer system which the user can operate and manipulate through the client system, as if he were working at a conventional lab computer system. The preferred embodiment allows the user to save the state of the lab at any time, to resume later, and will load specific system states on the virtual lab computer system according to the user's identity and selections.

### TECHNICAL FIELD OF THE INVENTION

The present invention is directed, in general, to remote educations systems.

### BACKGROUND OF THE INVENTION

The current trend towards corporate training delivered via a corporate intranet works very well for curriculums that consist primarily of reading words and looking at pictures. Technical training that includes a hands on component, or lab, are at risk because the training is not as effective without the hands on portion.

Some training curriculums use simulations to enhance “book learning” and while better than no “hands on” at all, simulations always move toward an anticipated result. This structured flow is not a true indication of how technologies work in the real world.

It is therefore desirable to produce a “live” environment where a student can perform lab work but a student that deviated from the anticipated actions would experience the same problems and machine responses as would be found in the real world. This type of hands-on experience is essential to maximize the student's ability to perform his job functions.

### SUMMARY OF THE INVENTION

To address the above-discussed deficiencies of the prior art, it is a primary object of the present invention to provide an improved system, method, and computer program product for remote education.

The preferred embodiment provides a system, method, and computer program product for a remotely accessible, on-line virtual-system education lab. In this embodiment, students can connect with the lab server from any client system connected, directly or indirectly, with a common network, using a conventional web browser or other thin-client interface. When the client connects, the server will create a virtual lab computer system which the user can operate and manipulate through the client system, as if he were working at a conventional lab computer system. The preferred embodiment allows the user to save the state of the lab at any time, to resume later, and will load specific system states on the virtual lab computer system according to the user's identity and selections.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the. functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system network in accordance with a preferred embodiment of the present invention; and

FIG. 2 depicts a flowchart of a process in accordance with a preferred embodiment of the present invention.

### DETAILED DESCRIPTION OF THE INVENTION

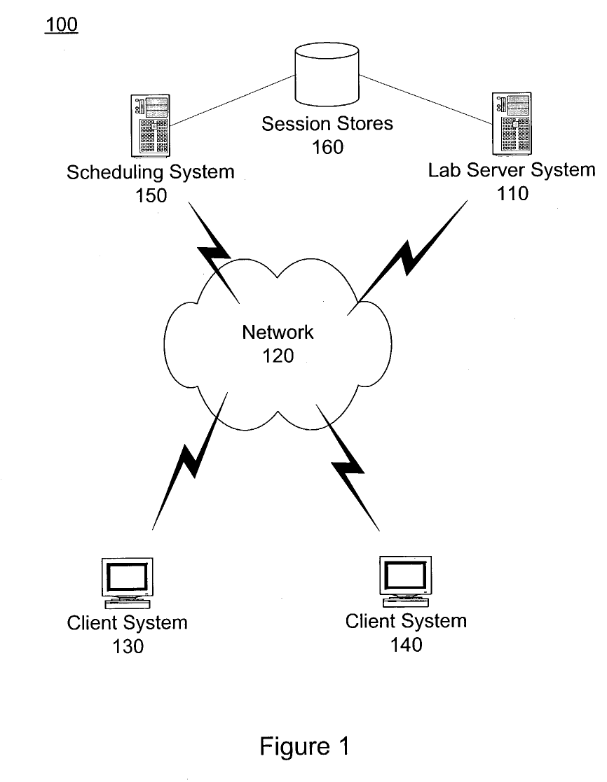

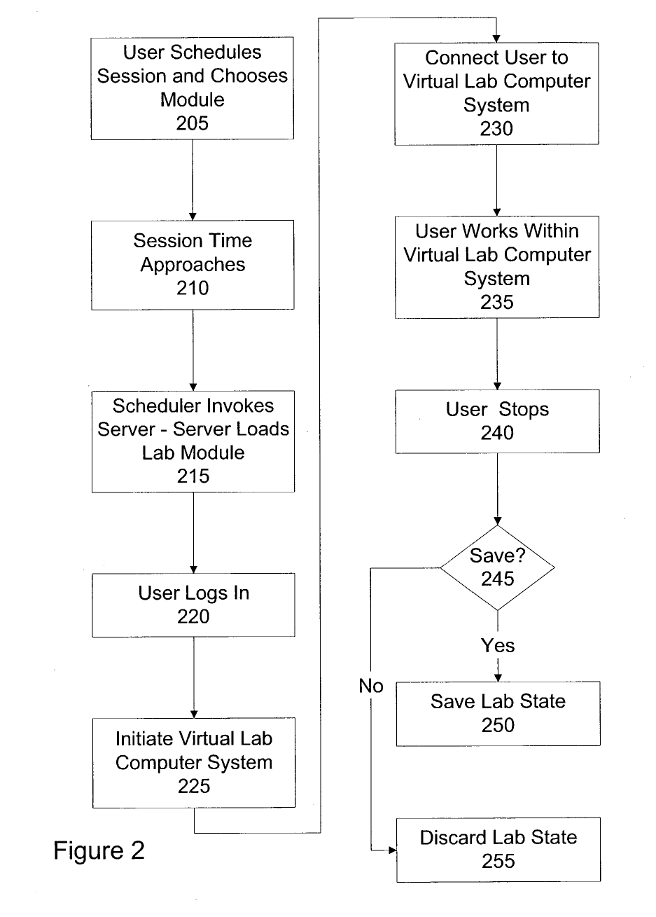

FIGS. 1 and 2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment provides a system, method, and computer program product for a remotely accessible, on-line virtual-system education lab. In this embodiment, students can connect with the lab server from any client system connected, directly or indirectly, with a common network, using a conventional web browser or other thin-client interface. When the client connects, the server will create a virtual lab computer system which the user can operate and manipulate through the client system, as if he were working at a conventional lab computer system. The preferred embodiment allows the user to save the state of the lab at any time, to resume later, and will load specific system states on the virtual lab computer system according to the user's identity and selections.

FIG. 1 depicts a block diagram of a data processing system network 100 in accordance with a preferred embodiment of the present invention. In this figure, lab server system 110 is shown connected to network 120. Lab server system 110 may be implemented in any conventional data processing system having at least a processor, accessible memory, and a network connection. Lab server system 110 is configured and programmed to perform the tasks as described below.

Network 120 may be any known networking system, including intranet and extranet networks, local-area networks (LANs), direct connection and dialup networking, and the public Internet. Also connected to network 120 are client systems 130 and 140. Client systems 130 and 140 are data processing systems configured to communicate with lab server system 110, either separately or simultaneously. Client systems 130 and 140 are configured and programmed to perform the tasks as described below. It should be noted that the preferred system and method are not limited to the two exemplary client systems shown, but may support any number of client systems, as a particular implementation requires.

Further, the client systems shown can be used either for a student system, for performing an activity within the virtual lab system, or for an instructor system, for overseeing, teaching, guiding, and otherwise working with the students on other client systems.

The preferred embodiment combines existing technologies with new processes and technologies in such a way to create a virtual computing environment that is accessible across a network. This environment allows students and instructors to be geographically dispersed while working together in a “live” lab environment that reacts the same way a dedicated lab machine would react if the participants were actually sitting at the keyboard.

The disclosed process allows an educator to create a hardware/software environment suitable for use in class labs. The environment is then made available to students across the network 120 using, in the preferred embodiment, Microsoft Windows Terminal Services. Further, the multiple students can share a single hardware platform, each student accessing a separate virtual lab system.

Also disclosed is a scheduling system 150, which communicates with the client systems 130 and 140 and with the lab server system 110. The scheduling system 150 allows student and instructors to schedule lab sessions. In this way, the scheduling system will, in advance of a scheduled session, prepare the virtual lab system for student or instructor interaction, without requiring the student or instructor to wait for the virtual lab system to be initialized.

Also, the lab server system 110 can store and load lab states, either through the scheduling system 150 or independently, allowing a student to save a lab off to a storage area 160 on the lab server system and maintain the state of the lab so it can be revisited and completed at a later time. Further, this capability allows the educator to design and specify particular lab states in order to educate and test the students on particular events or techniques. In this case, the lab server system 110 will load a stored lab state from session stores 160 into the virtual lab system, and present this to the user through his browser or thin-client interface.

The sessions stores 160 stores multiple stored lab states which can be used as template images to allow students to restore a virtual system to a known state, to start at a specific portion or module of an education course, or to allow the instructor to define specific activities and events. The sessions stores also allow the students to save their sessions, to resume them later from the same point.

In the preferred embodiment, scheduling system 150 is connected to and manages the session stores 160, and lab server system 110 is also connected to communicate with the session stores 160. However, in other embodiments, the lab server system 110 manages the stores. In still other embodiments, scheduling system 150, lab server system 110, and session stores 160, or any combination of them, are implemented in the same data processing system.

The disclosed embodiments can be used for any education system wherein the student is learning to accomplish some task through use of a computer system or computer system software, by creating a virtual lab system in which the student can perform the required tasks or use a virtual version of the software. As such, the virtual lab environment may simply include a single virtual computer system running a specific software, may represent multiple virtual computer systems connected in a virtual network, or may include any combination of computer systems, networks, interfaces, software applications, etc.

Some of the advantages of the preferred embodiment include:

Travel Savings—It is no longer necessary for students to travel to training centers which have computer resources which match the required training. The disclosed embodiments make it possible for the hardware resources to be made available at the student desktop regardless of location.

Hardware Improvement—When an instructor travels to a site that does not have the correct hardware or software for class exercises, the disclosed techniques can be used to provide appropriate access to the technology via the virtual lab system.

Improved Convenience—When a student does not have time to complete a technical class in one session the computer environment can be saved to a storage area network and reloaded when the student is ready to complete the class.

Improved Teaching—The instructor can use this technology to observe or participate in the student exercises improving the learning process. Further, it is possible for the instructor to be in two places at one time. For example, a single instructor can help students in seven time zones (or more) simultaneously.

Hardware Leverage—The use of the virtual lab system allows multiple students to connect to a single lab server system when doing lab work. This reduces hardware costs.

Improved Fault Resolution—If the student performs actions outside of the planned activities, the virtual lab system may “hang” or produce other errors consistent with the use of an actual lab computer system. In this case, the instructor may join the session to fix things, or can reload the virtual lab system with a known “good” state for the student to resume his work.

Reduced Risk of System Corruption—Since the students will be learning on a virtual lab system, there is no longer a risk that the student will corrupt or damage their own system or company system by attempting to perform a lab exercise on those actual systems.

Licensing Savings—Students will not be required to own a license to a product they are learning, since it is no longer necessary for the student to be locally executing the application itself.

The preferred embodiment can be implemented using multiple technologies commonly used in the industry. These technologies include, but are not limited to, Windows Terminal Services; Microsoft Sysprep utility; VMWare; Networking (Ethernet, TCP/IP); Citrix (when going through a firewall); and Storage Area Network (EMC).

Additionally, various scripts and software are used to build, save & restore the machines, to schedule the use of lab machines, and to manage multiple virtual lab machines on one system. These scripts and software are customized to the particular application, and the programming and implementation of these is within the abilities of one of skill in the art.

FIG. 2 shows a flowchart of a process in accordance with the preferred embodiment. Here, the user or alternately, the instructor, schedules a session on the scheduling system and chooses a module from the session stores (step 205). As the scheduled session time approaches (step 210), the scheduling system will invoke the server and have it load the chosen lab module (step 215). Because the process of loading a module and initializing a virtual lab environment can often take several minutes, the scheduler will prepare the session in advance of the scheduled time, so the user does not have to wait for initialization.

Next, the user connects with and logs into the virtual lab server (step 220). The virtual lab server then initiates a virtual lab computer system, corresponding to the server state that was loaded by the scheduler (step 225). The user is then connected to the virtual lab computer system (step 230). The user then works within the virtual lab computer system, using his browser or other thin client, as if he were actually working on a dedicated lab computer system (step 235).

When the user stops working (step 240), it may be because he has completed the exercise, is taking a break, or another reason. The user is therefore given the option of saving his lab state (step 245). If he chooses to do so, the lab state is saved (step 250). If not, the lab state is discarded and any storage or memory used for it are freed for other tasks (step 255). At this point, that session of the virtual lab computer system is closed, while other sessions on the same virtual lab computer system may continue to operate.

The preferred embodiment provides that the virtual lab server system itself provides for multiple virtual lab computer system sessions. In this embodiment, the virtual lab server system will manage the allocation of memory, storage, and processor time needed for each virtual lab computer system session. In an alternate embodiment, the virtual lab computer systems are hosted on a separate data processing system than the virtual lab server system, and the virtual lab server system handles the connections and user management.

It is also provided that multiple sessions may interact; while each user will operate within his own session, the virtual lab computer systems in each session may interact with each other, as if they were independent systems in a computer network. This capability is also used to allow the instructor to interact or intercede with users. For example, an instructor may override a user's session, allowing the user to watch while the instructor himself “remote controls” the session and interacts with the virtual lab computer system.

Other features include the ability to pull up an exemplary screen-shot or fully-animated recording of a lab interaction, to let students see examples of how to perform their tasks correctly. Another feature is an integrated skills-assessment test, which evaluates the knowledge and skill level of a student, and from that information, starts the student on the appropriate stored session module.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of the disclosed data processing systems may conform to any of the various current implementations and practices known in the art.

It is important to note that while the present invention has been described in the context of a fully functional system, those skilled in the art will appreciate that at least portions of the mechanism of the present invention are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method, comprising:
receiving, in a server system, user identification from a client system;
loading, in the server system, lab state data corresponding to the user identification;
initiating a virtual lab computer system corresponding to the lab state data; and
allowing the client system to communicate with the virtual lab computer system, wherein the virtual lab computer system emulates a lab computer system to a user of the client system.

2. The method of claim 1, further comprising saving a stored lab state data corresponding to the user identification.

3. The method of claim 1, wherein the lab state data corresponds to a user's previously stored data.

4. The method of claim 1, wherein the lab state data corresponds to a student assignment.

5. The method of claim 1, wherein the virtual lab computer system allows a student to complete practice assignments as if the student were operating a lab computer system.

6. The method of claim 1, wherein multiple client systems connect to the server system simultaneously.

7. The method of claim 1, wherein multiple virtual lab computer systems operate on the server system simultaneously.

8. The method of claim 1, further comprising
receiving session schedule information including a session time, a user identifier, and a lab state data identifier, wherein the loading step is performed prior to the session time.

9. A server system having at least a processor and accessible memory, comprising:
means for receiving, in the server system, user identification from a client system;
means for loading, in the server system, lab state data corresponding to the user identification;
means for initiating a virtual lab computer system corresponding to the lab state data; and
means for allowing the client system to communicate with the virtual lab computer system, wherein the virtual lab computer system emulates a lab computer system to a user of the client system.

10. The server system of claim 9, further comprising means for saving a stored lab state data corresponding to the user identification.

11. The server system of claim 9, wherein the lab state data corresponds to a user's previously stored data.

12. The server system of claim 9, wherein the lab state data corresponds to a student assignment.

13. The server system of claim 9, wherein the virtual lab computer system allows a student to complete practice assignments as if the student were operating a lab computer system.

14. The server system of claim 9, wherein multiple client systems connect to the server system simultaneously.

15. The server system of claim 9, wherein multiple virtual lab computer systems operate on the server system simultaneously.

16. A computer program product tangibly embodied in a computer-readable medium, comprising:
instructions for receiving, in a server system, user identification from a client system;
instructions for loading, in the server system, lab state data corresponding to the user identification;
instructions for initiating a virtual lab computer system corresponding to the lab state data; and
instructions for allowing the client system to communicate with the virtual lab computer system, wherein the virtual lab computer system emulates a lab computer system to a user of the client system.

17. The computer program product of claim 16, further comprising instructions for saving a stored lab state data corresponding to the user identification.

18. The computer program product of claim 16, wherein the lab state data corresponds to a user's previously stored data.

19. The computer program product of claim 16, wherein the lab state data corresponds to a student assignment.

20. The computer program product of claim 16, wherein the virtual lab computer system allows a student to complete practice assignments as if the student were operating a lab computer system.

21. The computer program product of claim 16, wherein multiple virtual lab computer systems operate on the server system simultaneously.

22. A method, comprising,
receiving a virtual lab session reservation, including a reservation time and lab module identifier;
prior to the reservation time, initiating a virtual lab session corresponding to the lab module identifier, and
thereafter allowing a user to connect and communicate with the virtual lab session, wherein the virtual lab session emulates a lab computer system for the user.
